(19) United States
(12) Patent Application Publication
(10) Pub. No.: US 2025/0142209 A1
(43) Pub. Date: May 1, 2025

(54) IMAGE DISPLAY DEVICE

(71) Applicant: HTC Corporation, Taoyuan City (TW)

(72) Inventors: Kuei-Chun Liu, Taoyuan City (TW); Wei Chun Chen, Taoyuan City (TW)

(73) Assignee: HTC Corporation, Taoyuan City (TW)

(21) Appl. No.: 18/496,932

(22) Filed: Oct. 30, 2023

(51) Int. Cl. H04N 23/67; G02B 27/42; G06T 3/40

(52) U.S. Cl. CPC H04N 23/67; G02B 27/4205; G06T 3/40

(57) ABSTRACT

An image display device including a first lens set, a diffractive optical element (DOE), a second lens set and a coupler. The first lens receives a display image, and converts the display image into multiple image beams parallel to each other. The diffractive optical element receives the image beams, diffracts the image beams and generate multiple image sub-beams. The second lens set receives each of the image sub-beams corresponding to each of the image beams. The second lens set provides a focus length, and focuses the image sub-beams according to the focus length to generate multiple zoomed image sub-beams corresponding to each of the image beams. The coupler receives the zoomed image sub-beams, reflects the zoomed image sub-beams to a target plane, and causes the zoomed image sub-beams to form multiple image imaging points on the target plane.

### BACKGROUND

### Technical Field

The disclosure relates to an image display device, in particular to an image display device having a function of adjusting a distance between viewpoints.

### Description of Related Art

In the technical field of Augmented Reality (AR), optical designs with fixed image depth are often used, such as waveguide and birdbath structures. If the external image viewed by the user and the virtual image provided by the augmented reality display are at different depths, it will be difficult for the user to see the external image and the virtual image clearly at the same time. Therefore, the eyes need to switch the focus on multiple focal planes for a long time, causing eyestrain.

### SUMMARY

The disclosure provides an image display device, which may have a function of adjusting a distance between viewpoints.

The image display device of the disclosure includes a first lens set, a diffractive optical element, a second lens set, and a coupler. The first lens set receives a display image and converts the display image into multiple image beams parallel to each other. The diffractive optical element receives the image beams, and diffracts each of the image beams to generate multiple image sub-beams. The second lens set receives the image sub-beams corresponding to each of the image beams. The second lens set provides a focus length and focuses the image sub-beams according to the focus length to generate multiple zoomed image sub-beams corresponding to each of the image beams. The coupler receives the zoomed image sub-beam, reflects the zoomed image sub-beam to a target plane, and causes the zoomed image sub-beam to form multiple image imaging points on the target plane.

Based on the above, the image display device of the disclosure converts each of the image beams into the image sub-beams through the diffractive optical element, and then cause the zoomed image sub-beams to form image imaging points on the target plane through the focusing action of the second lens set and the coupler, thereby generating multiple viewpoints. In the embodiments of the disclosure, the second lens set may adjust a distance between the viewpoints by adjusting the provided focus length, and expand the viewpoints to improve a display quality of an image.

### BRIEF DESCRIPTION OF THE DRAWINGS

FIG. 1 is a schematic diagram of an image display device according to an embodiment of the disclosure.

FIG. 2 is a schematic diagram of an imaging light path of an image display device according to the embodiment of the disclosure.

FIGS. 3A and 3B are schematic diagrams of different implementations of an image display device according to the embodiment of the disclosure.

FIGS. 4A and 4B are schematic diagrams of different implementations of an image display device according to another embodiment of the disclosure.

FIG. 5 is a schematic diagram of multiple image imaging points formed on the target plane by the image display device according to the embodiment of the disclosure.

FIG. 6 is a schematic diagram of an image display device according to another embodiment of the disclosure.

### DESCRIPTION OF THE EMBODIMENTS

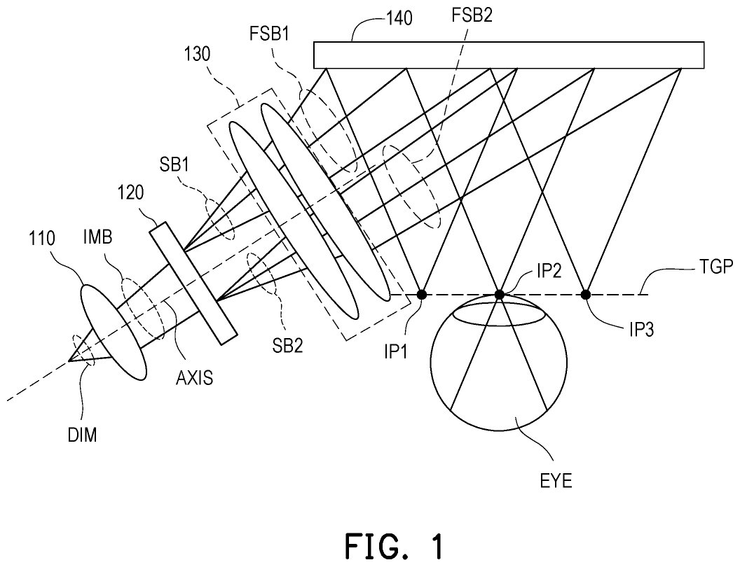

Please refer to FIG. 1. FIG. 1 is a schematic diagram of an image display device according to an embodiment of the disclosure. The image display device may be disposed in an augmented reality display. The image display device includes lens sets 110 and 130, a diffractive optical element 120, and a coupler 140. The lens set 110, the diffractive optical element 120, the lens set 130, and the coupler 140 are sequentially disposed. Center points of the lens set 110, the diffractive optical element 120, and the lens set 130 may be set on an optical axis AXIS of a display image DIM received by the lens set 110.

In this embodiment, the lens set 110 is used to convert the received display image DIM into multiple image beams IMB. The display image DIM may be emitted by a light source and may be composed of multiple scattered light beams. The lens set 110 includes a collimation lens and is used to focus the received display image DIM to convert the display image DIM to generate the image beams IMB parallel to each other.

The diffractive optical element 120 is disposed adjacent to a light emitting surface of the lens set 110. The diffractive optical element 120 is used to receive the image beams IMB and diffract each of the image beams IMB to generate multiple image sub-beams SB1 and SB2. The diffractive optical element 120 projects the image sub-beams SB1 and SB2 to the lens set 130. The lens set 130 is a focus lens set. The lens set 130 provides a focus length and is used to focus the image sub-beams SB1 and SB2 according to the provided focus length, thereby respectively generating multiple zoomed image sub-beams FSB1 and FSB2.

The zoomed image sub-beams FSB1 and FSB2 are projected onto the coupler 140. The coupler 140 is used to reflect the zoomed image sub-beams FSB1 and FSB2, so that the reflected zoomed image sub-beams FSB1 and FSB2 are projected onto a target plane TGP, and the zoomed image sub-beams FSB1 and FSB2 form multiple image imaging points IP1 to IP3 on the target plane TGP.

In this embodiment, the target plane TGP is located at the position of an eyeball EYE of a user. The image imaging points IP1 to IP3 may form multiple viewpoints corresponding to the eyeball EYE of the user. In each of the viewpoints, the light beam at each angle records different image information. Moreover, in actual operation, the number of the zoomed image sub-beams may be more than 2, and the corresponding generated image imaging points may be distributed in an array, such as N times N, where N may be 3 or other integer greater than 3.

It should be particularly noted that the focus length provided by the lens set 130 may be adjusted. By adjusting the focus length provided by the lens set 130, a distribution range of the image imaging points IP1 to IP3 on the target plane TGP may be adjusted. When the lens set 130 provides a first focus length, the image imaging points IP1 to IP3 have a first distribution range on the target plane TGP; when the lens set 130 provides a second focus length, the image imaging points IP1 to IP3 have a second distribution range on the target plane TGP. When the first focus length is less than the second focus length, the first distribution range is less than the second distribution range.

In this embodiment, an angle between a normal vector of the coupler 140 and a forward direction of the zoomed image sub-beams FSB1 and FSB2 is not at 0 degree.

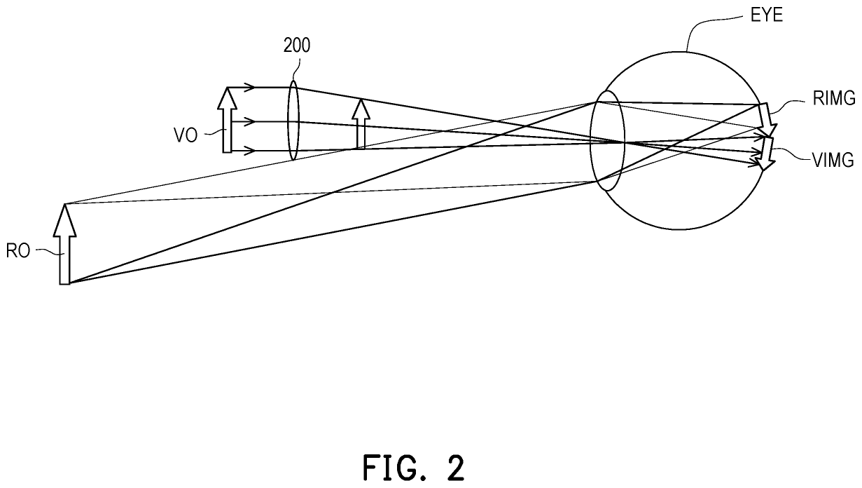

Please refer to FIG. 2 below. FIG. 2 is a schematic diagram of an imaging light path of an image display device according to the embodiment of the disclosure. An image display device 200 may be applied in the augmented reality display. The eyeballs of the user may observe a virtual object VO through the image display device 200, and may also directly observe an actual object RO. In FIG. 2, each of object points of the virtual object VO and the actual object RO only emits light beams in a single angular direction. The eyeball EYE of the user does not need to converge a virtual image beam. Therefore, imaging images VIMG and RIMG respectively generated corresponding to the virtual object VO and the actual object RO may present clear images regardless of a distance of an actual object the eyes focus on.

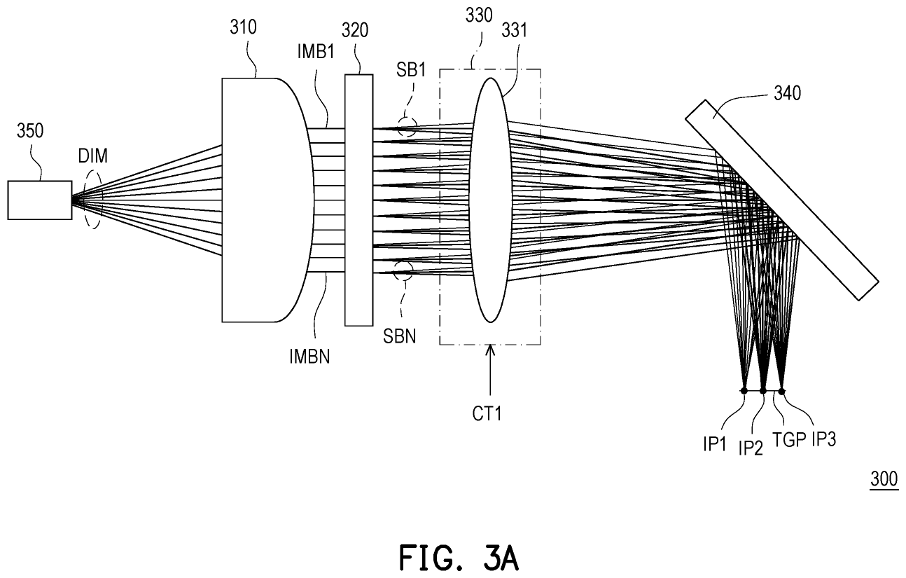

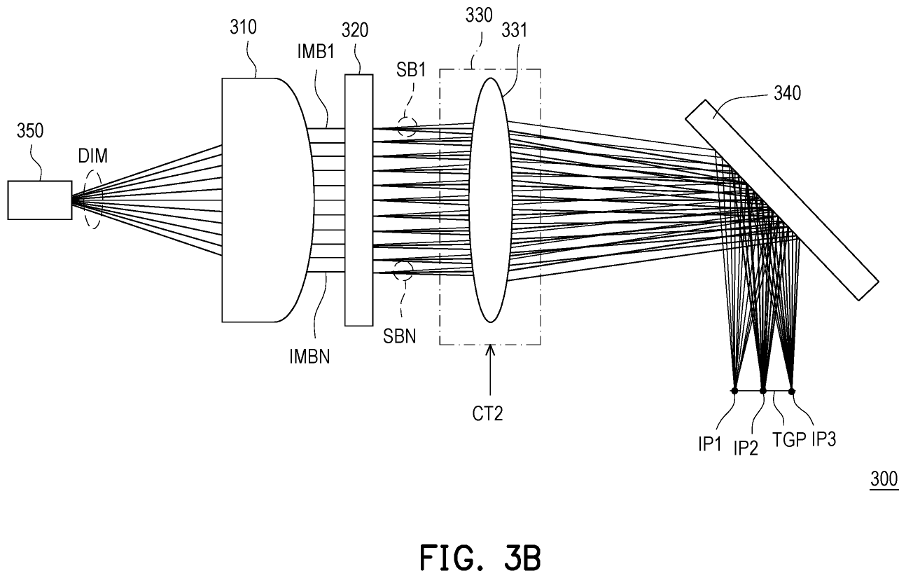

Please refer to FIGS. 3A and 3B. FIGS. 3A and 3B are schematic diagrams of different implementations of an image display device according to the embodiment of the disclosure. An image display device 300 may be disposed in the augmented reality display. The image display device 300 includes lens sets 310 and 330, a diffractive optical element 320, and a coupler 340. An image light source 350, the lens set 310, the diffractive optical element 320, the lens set 330, and the coupler 340 are sequentially disposed. The image light source 350 is used to project the display image DIM to the lens set 310. The lens set 310 is used to focus the display image DIM, which is a scattered light beam, and generate multiple image light beams IMB1 to IMBN as parallel lights. The lens set 310 projects the image beams IMB1 to IMBN to the diffractive optical element 320. The diffractive element 320 diffracts each of the image beams IMB1 to IMBN to respectively generate multiple image sub-beams SB1 to SBN.

The lens set 330 has a zoom lens 331. The zoom lens 331 may receive the image sub-beams SB1 to SBN and focus the image sub-beams SB1 to SBN to respectively generate the zoomed image sub-beams. The zoom lens 331 may be an electrically controlled zoom lens. In the embodiment of FIG. 3A, the zoom lens 331 may adjust the provided focus length to the first focus length according to a control signal CT1. The zoom lens 331 focuses the image sub-beams SB1 to SBN according to the first focus length, and provides the generated zoomed image sub-beams to the coupler 340. The coupler 340 is used to reflect the zoomed image sub-beams to the target plane TGP, and generate the image imaging points IP1 to IP3 on the target plane TGP. The zoomed image sub-beams corresponding to each of the image imaging points IP1 to IP3 respectively record different image information. The distribution of the image imaging points IP1 to IP3 may have a first range.

In addition, in the embodiment of FIG. 3B, the zoom lens 331 may adjust the provided focus length to a second focus length according to a control signal CT2. The second focus length may be greater than the first focus length. The zoom lens 331 focuses the image sub-beams SB1 to SBN according to the second focus length, and provides the generated zoomed image sub-beams to the coupler 340. The coupler 340 is used to reflect the zoomed image sub-beams to the target plane TGP, and generate the image imaging points IP1 to IP3 on the target plane TGP. The distribution of the image imaging points IP1 to IP3 may have a second range. The second range may be greater than the first range.

It may be known from the embodiments of FIG. 3A and FIG. 3B that the image display device 300 according to the embodiment of the disclosure may adjust the distribution range of the image imaging points IP1 to IP3 by adjusting the focus length provided by the lens set 330, and further adjust the distance between each of the viewpoints.

In this embodiment, the image light source 350 may be a scanning laser light source. The lens set 310 may be a collimation lens.

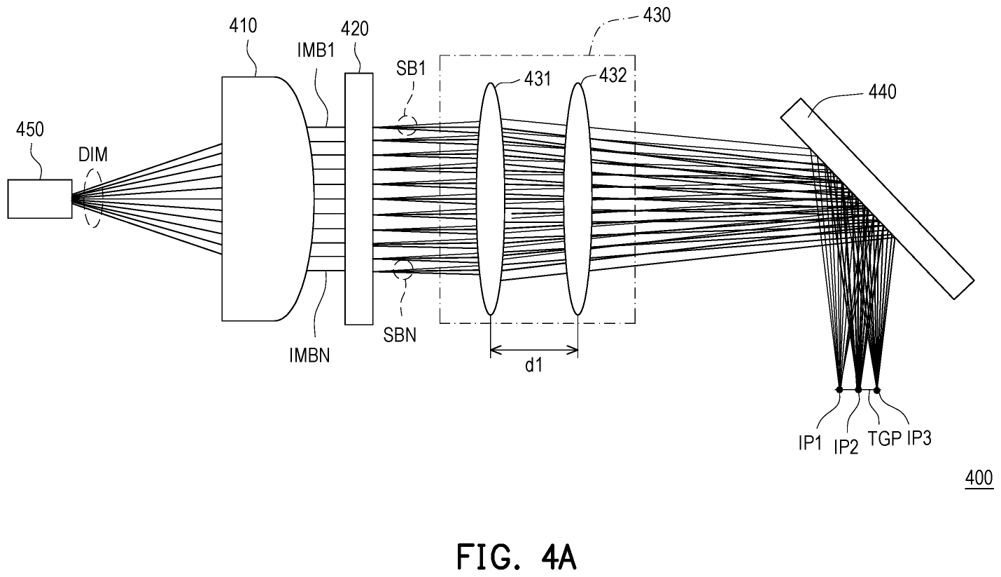

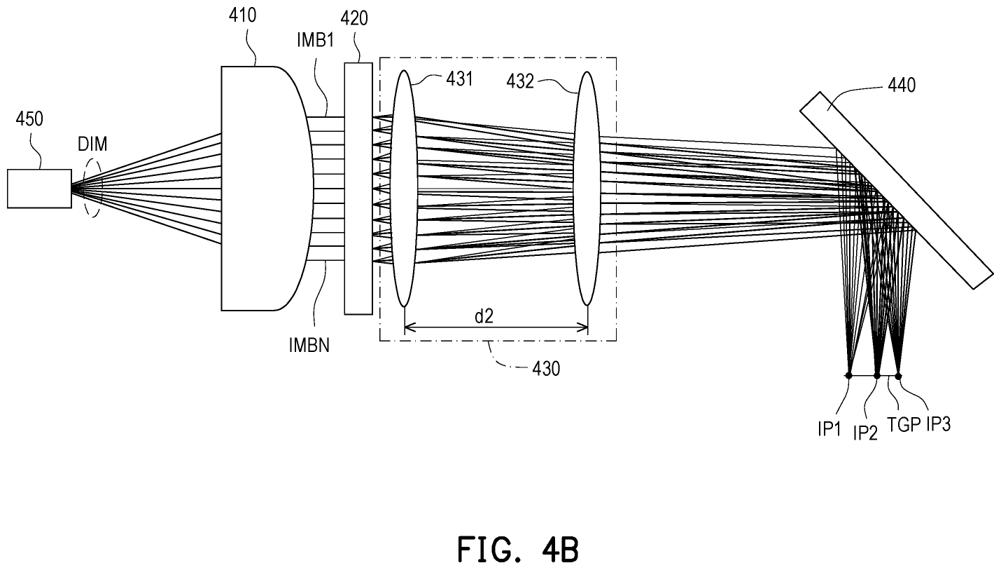

Please refer to FIGS. 4A and 4B. FIGS. 4A and 4B are schematic diagrams of different implementations of an image display device according to another embodiment of the disclosure. An image display device 400 includes lens sets 410 and 430, a diffractive optical element 420, and a coupler 440. An image light source 450, the lens set 410, the diffractive optical element 420, the lens set 430, and the coupler 440 are sequentially disposed. Similar to the embodiments of FIGS. 3A and 3B, the image light source 450 is used to project the display image DIM to the lens set 410. The lens set 410 is used to focus the display image DIM, which is the scattered light beam, and generate the image light beams IMB1 to IMBN as parallel lights. The lens set 410 projects the image beams IMB1 to IMBN to the diffractive optical element 420. The diffractive optical element 420 diffracts each of the image beams IMB1 to IMBN to respectively generate the image sub-beams SB1 to SBN.

Different from the embodiments of FIGS. 3A and 3B, the lens set 430 includes a first lens 431 and a second lens 432. The first lens 431 and the second lens 432 are arranged parallel to each other. Both of the first lens 431 and the second lens 432 may be focus lenses. In FIG. 3A, the center points of the first lens 431 and the second lens 432 have a spacing distance d1. The first lens 431 may receive the image sub-beams SB1 to SBN, and the second lens 432 receives an outgoing beam of the first lens 431 and projects the generated zoomed image sub-beam to the coupler 440.

Under a status that both the first lens 431 and the second lens 432 are focus lenses with a fixed focus length, the spacing distance d1 between the first lens 431 and the second lens 432 may determine the focus length provided by the lens set 430 as the first focus length, so that the distribution of the image imaging points IP1 to IP3 generated on the target plane TGP may have the first range.

In FIG. 3B, the center points of the first lens 431 and the second lens 432 have a spacing distance d2. The spacing distance d2 is greater than the spacing distance d1. Similarly, under the status that both of the first lens 431 and the second lens 432 are focus lenses with a fixed focus length, the spacing distance d2 between the first lens 431 and the second lens 432 may determine the focus length provided by the lens set 430 as the second focus length, so that the distribution of image imaging points IP1 to IP3 generated on the target plane TGP may have the second range. The first focus length is less than the second focal length, and the first range may be less than the second range.

In the embodiment of FIG. 4A and FIG. 4B, the lens set 430 may effectively adjust the focus length of the lens set 430 by adjusting the spacing distance between the first lens 431 and the second lens 432. In this way, the distribution range of the image imaging points IP1 to IP3 may be adjusted, and the distance between the viewpoints may be adjusted.

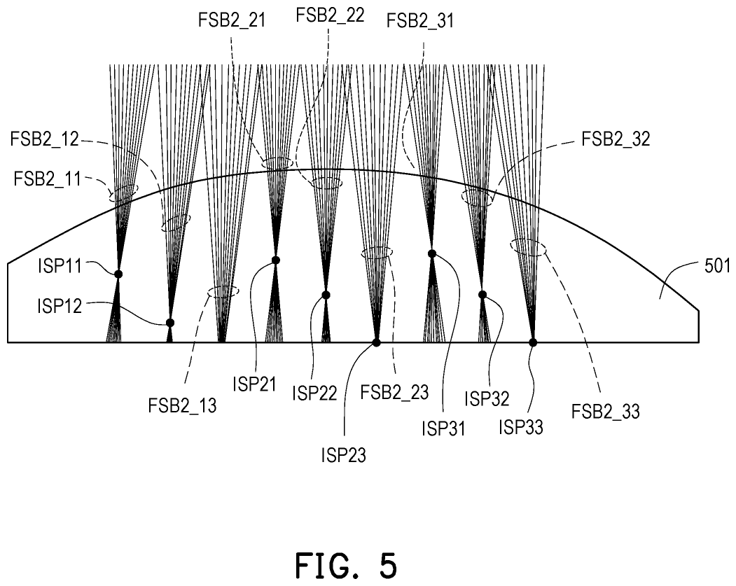

Please refer to FIG. 5. FIG. 5 is a schematic diagram of multiple image imaging points formed on the target plane by the image display device according to the embodiment of the disclosure. In this embodiment, multiple zoomed image sub-beams FSB2_11 to FSB2_33 may form an array of three times three and enter an eyeball 501 of the user. The zoomed image sub-beams FSB2_11 to FSB2_33 are respectively focused to form the array of three times three of image imaging points ISP11 to ISP33.

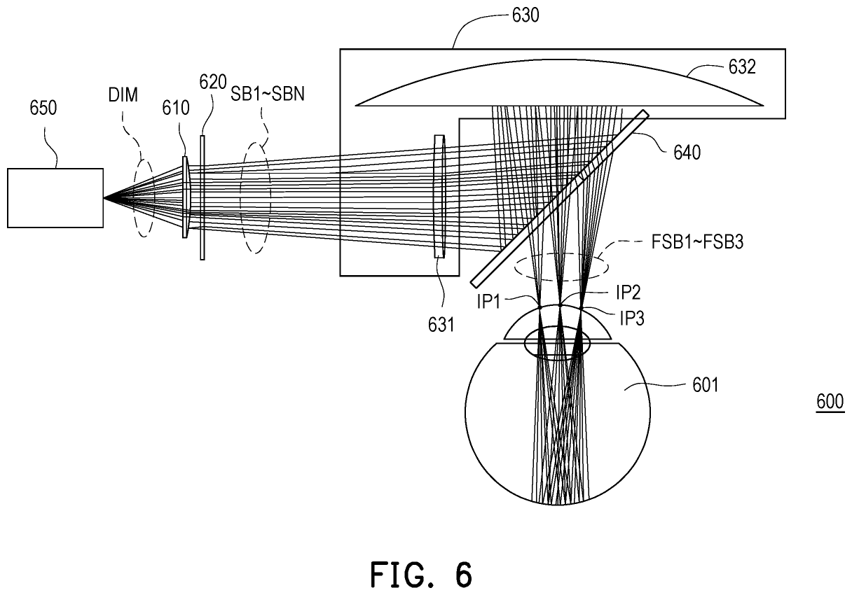

Please refer to FIG. 6. FIG. 6 is a schematic diagram of an image display device according to another embodiment of the disclosure. The image display device 600 may be disposed in the augmented reality display. The image display device 600 includes an image light source 650, lens sets 610 and 630, a diffractive optical element 620, and a coupler 640. The image light source 650 is used to project the display image DIM to the lens set 610. The lens set 610 is used to focus the display image DIM, which is the scattered light beam, and generate the image light beams as parallel lights. The lens set 610 projects the image light beams to the diffractive optical element 620. The diffractive optical element 620 diffracts each image beam to respectively generate the image sub-beams SB1 to SBN.

Different from the previous embodiments, the lens set 630 includes a lens 631 and a concave mirror 632. The lens 631 is disposed between the diffractive optical element 620 and the coupler 640. The lens 631 receives the image sub-beams SB1 to SBN and generates multiple first light beams by focusing the image sub-beams SB1 to SBN. The lens 631 transmits the generated first light beams to the coupler 640. The coupler 640 may reflect the first light beams to generate multiple second light beams and project the second light beams onto a reflective surface of the concave mirror 632. The concave mirror 632 is used to focus and reflect the received second light beams to generate a third light beam. The concave mirror 632 projects the third light beam to the coupler 640. Further, the coupler 640 may transmit the third light beam to generate multiple zoomed image sub-beams FSB1 to FSB3. The zoomed image sub-beams FSB1 to FSB3 may be focused in an eyeball 601 of the user, and respectively generate image imaging points ISP1 to ISP3.

It is worth noting that in this embodiment, by adjusting the distance between the lens 631 and the coupler 640 or adjusting the distance between the concave mirror 632 and the coupler 640, the focus length provided by the lens set 630 may be adjusted, thereby further adjusting the distribution range of the image imaging points ISP1 to ISP3. In addition, by adjusting the focus length of at least one of the lens 631 and the concave mirror 632, the focus length provided by the lens set 630 may also be adjusted.

To sum up, the image display device of the disclosure is designed to have a large depth of field optical image and may provide clear images when the eyeball is focused on any focus plane. The image display device of the disclosure has a function of expanding the viewpoints and adjusting the distance between the viewpoints at the same time. The expansion of the number of viewpoints may make it easier for the user to receive the viewpoint light beams, and have the function of adjusting the distance of the viewpoints to prevent the user from receiving multiple viewpoints and generating ghost images. The user may have a proper image quality with the function of expanding vision points and adjusting distance at the same time.

What is claimed is:

1. An image display device, comprising:
a first lens set, receiving a display image, and converting the display image into a plurality of image beams parallel to each other;
a diffractive optical element, receiving the plurality of image beams, and diffracting each of the plurality of image beams to generate a plurality of image sub-beams;
a second lens set, receiving the plurality of image sub-beams corresponding to each of the plurality of image beams, wherein the second lens set provides a focus length, and focuses the plurality of image sub-beams according to the focus length to generate a plurality of zoomed image sub-beams corresponding to each of the plurality of image beams; and
a coupler, receiving the plurality of zoomed image sub-beams, reflecting the plurality of zoomed image sub-beams to a target plane, and causing the plurality of zoomed image sub-beams to form a plurality of image imaging points on the target plane.

2. The image display device according to claim 1, wherein the second lens set comprises a variable focus lens.

3. The image display device according to claim 1, wherein the second lens set adjusts a distribution range of the plurality of image imaging points on the target plane by adjusting the provided focus length.

4. The image display device according to claim 2, wherein in response to the second lens set providing a first focus length, the plurality of image imaging points have a first distribution range on the target plane, in response to the second lens set providing a second focus length, the plurality of image imaging points have a second distribution range on the target plane, wherein in response to the first focus length being less than the second focus length, the first distribution range is less than the second distribution range.

5. The image display device according to claim 1, wherein the second lens set comprises:
a first lens; and
a second lens, arranged parallel to the first lens, wherein a spacing distance is between a center point of the second lens and a center point of the first lens.

6. The image display device according to claim 5, wherein in response to the spacing distance being a first distance, the second lens set provides a first focus length, and in response to the spacing distance being a second distance, the second lens set provides a second focus length, wherein the first distance is less than the second distance, and the first focus length is less than the second focus length.

7. The image display device according to claim 5, wherein both of the first lens and the second lens are focus lenses.

8. The image display device according to claim 1, wherein the second lens set comprises:
a first lens, receiving the plurality of image sub-beams corresponding to each of the plurality of image beams, focusing the plurality of image sub-beams to generate a plurality of first light beams, and projecting the plurality of first light beams to the coupler, wherein the coupler reflects the plurality of first light beams to respectively generate a plurality of second light beams; and
a concave mirror, receiving the plurality of second light beams, and reflecting and focusing the plurality of second light beams to generate a plurality of third light beams,
wherein the plurality of third light beams are projected onto the coupler, and the coupler transmits the plurality of third light beams to generate the plurality of zoomed image sub-beams.

9. The image display device according to claim 1, wherein the plurality of image imaging points are distributed on the target plane in an array.

10. The image display device according to claim 1, wherein an angle between a normal vector of the coupler and a forward direction of the zoomed image sub-beam is not at 0 degree.

11. The image display device according claim 1, further comprising:
an image light source, disposed to emit the display image.

12. The image display device according to claim 11, wherein the image light source is a scanning laser light source.

13. The image display device according to claim 1, wherein center points of the first lens set, the diffractive optical element, and the second lens set are arranged on an optical axis of the plurality of image light beams.

14. The image display device according to claim 1, wherein the plurality of zoomed image sub-beams of each of the plurality of image imaging points respectively record a plurality of different image information.

15. The image display device according to claim 1, wherein the first lens set comprises a collimation lens.
